(19) United States
(12) Patent Application Publication
(10) Pub. No.: US 2015/0053504 A1
(43) Pub. Date: Feb. 26, 2015

(54) Ladder safety lelel ("LSL")

(71) Applicant: Kevin G. Ross, Sacramento, CA (US)

(72) Inventors: Kevin G. Ross, Sacramento, CA (US); Andre K. Catellier, Sacramento, CA (US); Mark T. Beadleston, Sacramento, CA (US)

(21) Appl. No.: 14/120,633

(22) Filed: Jun. 12, 2014

(51) Int. Cl. E06C 7/00

(52) U.S. Cl. CPC E06C 7/003
USPC 182/204

(57) ABSTRACT

A safety device for non-self supporting ladders, straight or extension, which provides the user exact indication when the correct and legal ladder inclination is achieved at set-up and during ladder use allowing safe climbing or descent of the ladder. The device color is a visual safety prompt on the exterior of the ladder and provides supervisory monitoring. Said safety device is automatically self-calibrating and permanently calibrated in the ladder with a revolutionary easy nontechnical insertion into the rung opening located on the side of ladders. The device uses a simple bubble level inside a revolutionary housing whereas when the bubble is inside the lines of the level, the ladder is at a safe inclination and the rungs are level. The safety device does not require specific language knowledge, is independent of ladder length, user characteristics, user training, user knowledge and does not affect whatsoever any other ladder functions.

### BACKGROUND OF INVENTION

The safe inclination set-up of any straight or extension ladder against a vertical structure prior to climbing or Descending said ladder is critical for the safety of the user and the use of its ladder in its optimum stability and structural conditions. The installation angle of a ladder, often called ladder pitch, is exactly prescribed by the legal requirements of the Occupational Safety and Health Administration (OSHA Federal regulations Part 1926, Standard Number 1926.1053 Subpart X) and is also prescribed by ladder manufacturers because it is at this specific angle that ladders are certified by testing by the American National Standards Institute to certify the optimum structural capacity, to certify optimum ladder's resistance against base slip out, and that the ladders are at optimum stability with the ladder's rungs level for the user's feet.

The LADDER SAFETY LEVEL (hereafter referred to as “LSL”), is an entirely new invention and a revolutionary universal safety and measuring device for ladders including non-self supporting portable such as straight and extension ladders because there are no such devices in use today on ladders.

The LSL is a revolutionary safety device that holds a standard bubble level in a housing to indicate to any ladder user, experienced or inexperienced, when the ladder is erected at the safe, technically correct and legally required angle

The LSL is uniquely revolutionary because

1. The LSL is an actual measurement device integrated to the ladder providing visual measurement and monitoring.

2. The LSL is permanent, self-calibrating and remains calibrated.

3. The LSL has a revolutionary housing containing a bubble level and held inside the ladder by a snap button ring.

4. The LSL does not affect whatsoever any other ladder operations, use, handling, transporting, and storage.

5. The LSL is permanent and modifiable inside the rung of a ladder through its side opening.

6. The LSL is universal to all languages of all and any user with little or no instructions

7. The LSL is an exact measurement system without any guessing, not subject to ladder length and user body characteristics.

8. The LSL can be verified by others or anyone near the ladder prior to ladder use or during ladder use.

This current method and standard is the anthropometric method. Research results as well as common sense evaluation of ladder use readily indicates the anthropometric method is associated with large angle set-up variability because of ladder length, variability in human anthropometry as well as training and proper application. In addition, the user, or a monitor, cannot actually know or measure the correctness of the angle or its change during ladder use. In many case, the bilingual labels cannot be read by ladder uses of other languages. The current method is highly variable and unverifiable.

In accordance with the Bureau of Labor Statistics, slipping of a ladder base has been identified as a leading cause for ladder fall incidents. Fall incidents because of slide-out event are usually related to suboptimal ladder inclination angle. In 2008 alone, there were over 17,000 injuries related to ladder falls. Obviously, the current methods require improvement and replacement.

### PATENT REFERENCES

U.S. Pat. No. 8,167,087, B2, May 1, 2012 Multimodal Indicator Safety Device for Ladder Positioning

U.S. Patent Application US 2011/0127110 A1, Jun. 2, 2011 Ladder Safety Accessory Kit

U.S. Pat. No. 7,392,593 B2, Jul. 1, 20018 Angle Meter and Spirit Level

U.S. Patent Application US 2008/0006479 A1, Jan. 10, 2008 Ladder Level Indicator

U.S. Pat. No. 6,966,403 B1, Nov. 22, 2005 Smart Ladder

U.S. Pat. No. 5,956,855 Sep. 28, 1999 Ladder Inclination Indicator

U.S. Pat. No. 5,740,881 Apr. 21, 1998 Safety Device for Detecting Improper Positioning of a Ladder

U.S. Pat. No. 5,680,707 Oct. 28, 1997 Ladder Inclinometer

U.S. Pat. Des 316,608 Apr. 30, 1991 Ladder Leveling Attachment

U.S. Pat. No. 4,669,195 Jun. 2, 1987 Guide Line Angle Indicator

U.S. Pat. No. 4,554,994 Ladder Safety Indicator

U.S. Pat. No. 3,118,234 Safe Inclination Indicator for Ladders

U.S. Pat. No. 2,845,719, Aug. 5, 1958 Indicator Device for Ladders and the Like

### BRIEF DESCRIPTION OF DRAWINGS

The simplicity of the invention is better understood with reference to the following drawings.

FIG. 1 is a side view of any erected straight or extension ladder (1) against any vertical wall (0). This side view of the ladder displays the standard side rung openings (2) and the legally prescribed and correct safe angle of ladder inclination (3) of 75.5 degrees. The side view shows a typical location (4) of the “LSL” invention in the ladder. Further details are shown in the detail view (5) where the housing of the invention (6) holding the bubble level (7) are illustrated.

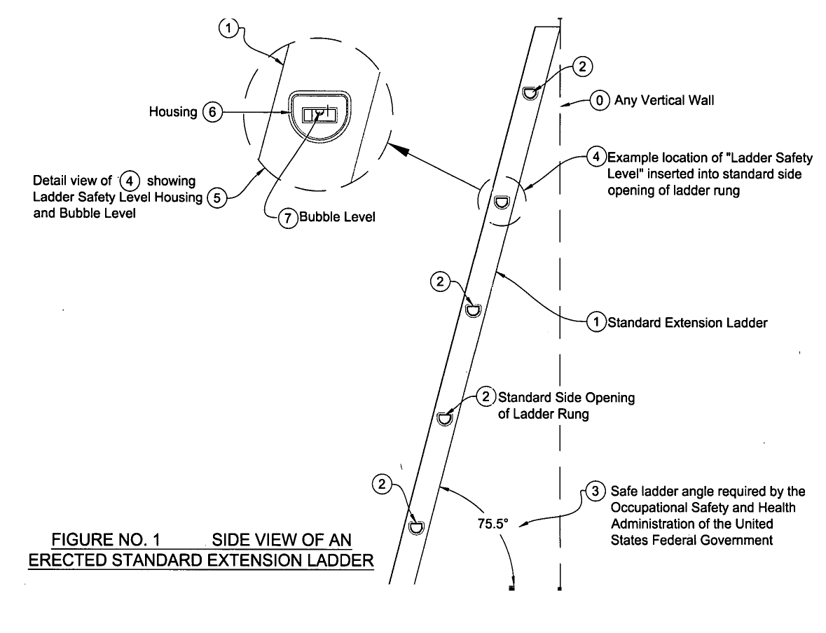

FIG. 2 is a front view of any erected straight or extension ladder (1) depicting the rungs (8) of the ladder (1). Again, the typical location (4) of the invention in the ladder is shown. Further details are shown in the exploded view to the side where the side view of the housing (6) is shown with the attachment snap button spring (9) and the final configuration of the invention (10) is shown.

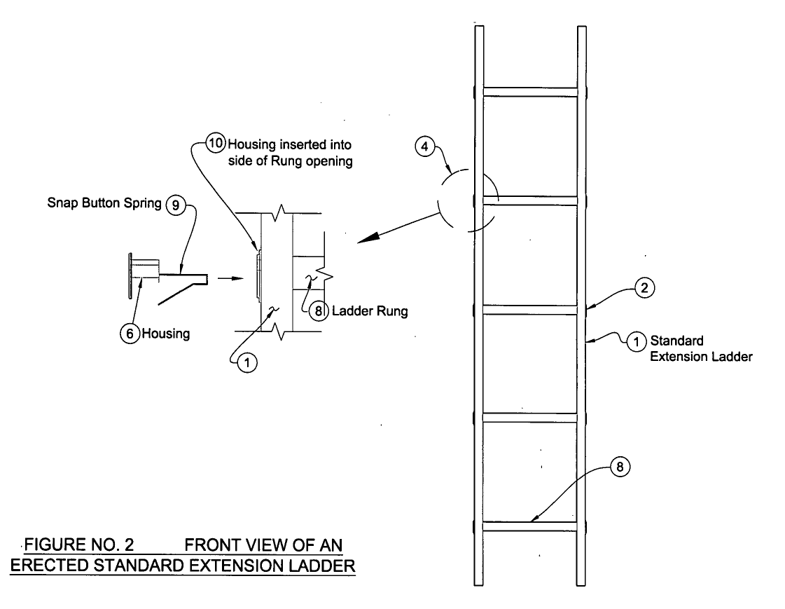

FIG. 3 is a partial isometric view of the ladder (1) with the rung (8) with the standard side rung opening (2) where the isometric view depicts the invention housing (6) with the location of the bubble level indicator (11) and the snap button spring in the rear for attachment (9) with the direction of insertion into the side opening of a rung.

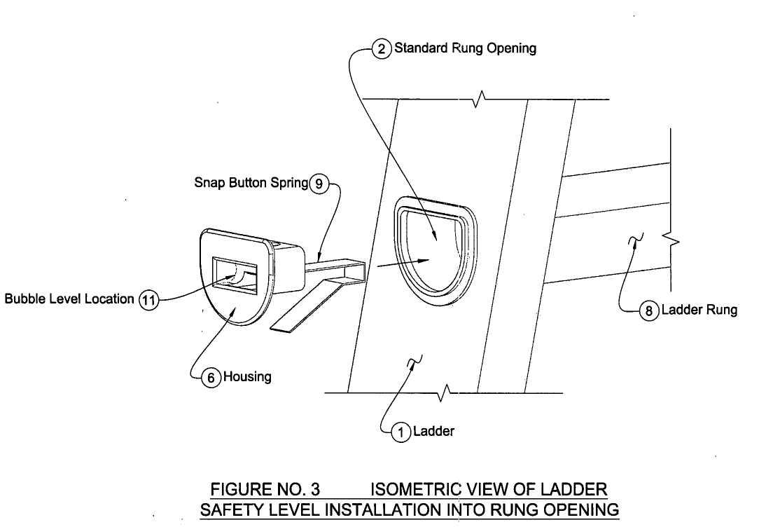

FIG. 4 is isometric front and rear views of the housing (6) with the snap button spring (9) and the location (11) of the bubble level.

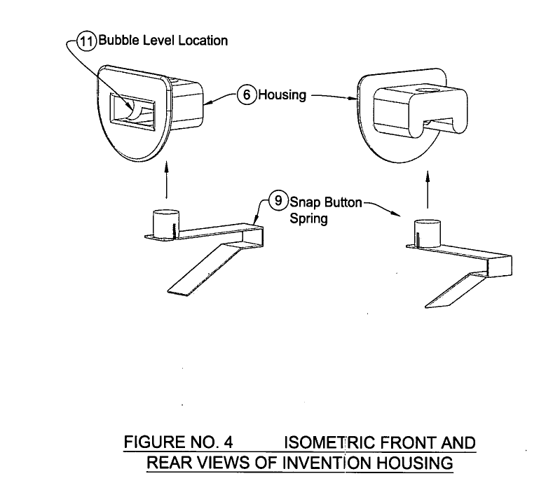

FIG. 5 is the Engineering and Isometric view of the revolutionary housing (6) that holds the bubble level and is inserted into the standard side opening of a ladder rung.

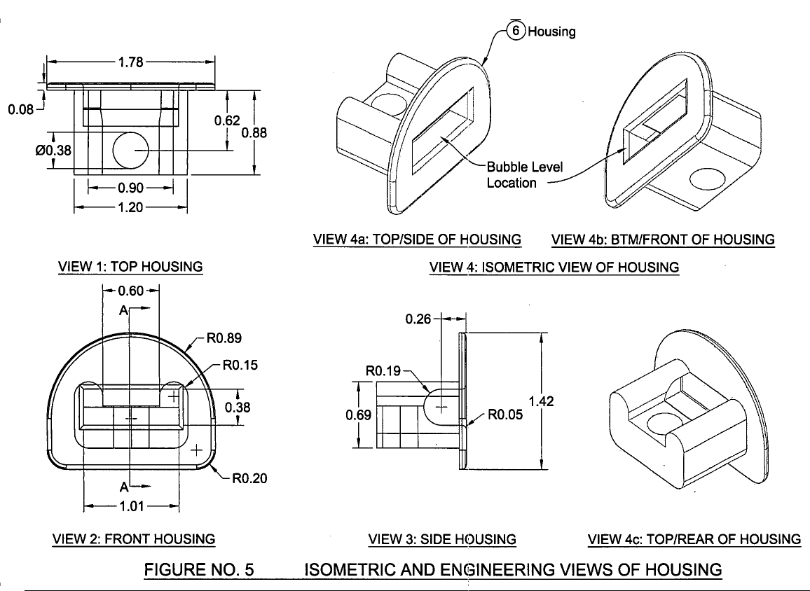

The LADDER SAFETY LEVEL (hereafter referred to as “LSL”), is an entirely new invention of a revolutionary universal safety device for non-self supporting portable and extension ladders.

The LSL can be manually installed by insertion into the open side voids of any ladder rung and becomes a permanent part of the ladder. At this location, the LSL will indicate if an erected ladder is safely erected at its safe and legally required pitch angle of 75.5 degrees. The LSL indicates when the Ladder is ready for safe climbing and the reading can be easily seen without obstruction before climbing the ladder. The LSL is installed on both sides of the ladder and can be installed at the top and the bottom, for a total of four (4) per ladder.

OSHA Federal regulations Part 1926, Standard Number 1926.1053 Subpart X for Ladders requires all non-self supporting extension ladders to be erected to a pitch of 75 ½ degrees from the horizontal for resistance against the bottom of the ladder sliding out, strength of the ladder, leveling of the rungs which a climbers feet rest upon and for optimum balance of the climber. It is at this angle that all ladders are certified by Regulatory Governing Federal and State Agencies.

The LSL is a revolutionary safety device that holds a standard bubble level to indicate to any ladder climber in an absolutely universally understood manner when the ladder is erected at the proper legal and technically correct pitch with the ladder rungs level, thus ready for safe climbing. The new LSL device integrates this bubble level into a special housing attachment, which becomes automatically calibrated when inserted into the open side void of any ladder rung. The housing is universal to all ladders.

The LSL is a device consisting of three parts. First, there is the revolutionary invented “D” shaped plastic housing, the second is the “bubble level indicator” and the third is the “snap button spring” in the back.

The revolutionary invented “D” shaped plastic housing clutches the indicator bubble level and has an attaching “metal snap button spring” mechanism in the back. The LSL housing is made of durable hard plastic, UV resistant and uniquely designed and fabricated to universally fit securely into the side voids of all ladder rungs and be automatically calibrated. When inserted, the LSL special housing automatically ensures that the bubble level is calibrated and when the bubble is between the indicator lines, the ladder is automatically at the proper pitch. The housing is Safety Yellow in Color with the initials LSL recorded on it.

The second component, which is the “bubble level indicator”, is securely held a1id protected inside the LSL housing. This bubble indicator is a universal component, internationally recognized irrespective of language as level indicator with two vertical lines and a bubble inside a fluid.

Finally, there is the special attachment in back, which is a Snap Button Spring holding the LSL housing into position inside any ladder rung. The attachment snap button spring is buttoned to the housing and ensures a permanent attachment inside a ladder rung and also ensures that once installed, the LSL will not move or create false readings of the proper pitch of the ladder

By its design, the LSL is securely fastened to the sides of the ladder, inside a ladder rung opening and does not conflict whatsoever the hands of the climber or with any other operations or use of the ladder whatsoever.

See the TWO (2) attached drawings stamped by a Registered Engineer in the State of California.

1. Ladder Safety Level in a Ladder Rung
The “Ladder Safety Level” comprising of a housing, a bubble level and a metal clip, wherein the bubble level is connected to the housing by insertion in a front slot and the metal clip is connected to the housing by insertion into a circular opening on the backside of the housing so that the housing with its bubble level and with its clip can be permanently connected to any standard extension ladder by insertion of said housing into the standard side opening of any rung of any non-self-supporting straight or extension ladder.
